(19) United States
(12) Patent Application Publication
(10) Pub. No.: US 2025/0384359 A1
(43) Pub. Date: Dec. 18, 2025

(54) METHOD AND SYSTEM FOR FINANCIAL FORECASTING

(71) Applicant: Panasonic Intellectual Property Management Co., Ltd., Osaka (JP)

(72) Inventors: Nway Nway AUNG, Singapore (SG); Yuejingxian Mao, Singapore (SG); Chandra Suwandi Wijaya, Singapore (SG); Ariel Beck, Singapore (SG); Sahim Yamaura, Singapore (SG); Yizhou Huang, Singapore (SG); Win Tun Lin, Singapore (SG); Koji Miura, Osaka (JP)

(21) Appl. No.: 19/012,371

(22) Filed: Jan. 7, 2025

Related U.S. Application Data
(60) Provisional application No. 63/659,115, filed on Jun. 12, 2024.

(51) Int. Cl. G06Q 10/04; G06Q 40/06; G06V 30/413

(52) U.S. Cl. CPC G06Q 10/04; G06Q 40/06; G06V 30/413

(57) ABSTRACT

A method for financial forecasting is disclosed. The method includes categorizing first content documents into a plurality of categories. Further, the includes computing a first relevancy score for each document based on expert input from real-world. Furthermore, the method includes determining second content documents based on correlating the first relevancy score with a predefined threshold score. The method is followed by determining time-series data based on computing an impact factor associated with each of a set of attributes associated with the second content documents. The impact factor indicates a significant quantification of a subsequent impact corresponding to the one or more entities in response to the second content documents. Moreover, the method includes generating disruption indexes based on integrating the time-series data and knowledge bases. The method further includes generating a forecast of the one or more entities based on the generated disruption indexes.

### CROSS-REFERENCE TO RELATED APPLICATIONS

The present application is based upon, and claims the benefit of priority to, U.S. Provisional Patent Application No. 63/659,115, filed on Jun. 12, 2024, the entire contents of which are hereby incorporated by reference.

### TECHNICAL FIELD

The present disclosure relates to forecasting, and more particularly, to a method and a system for financial forecasting.

### BACKGROUND

The information in this section merely provides background information related to the present disclosure and may not constitute prior art(s) for the present disclosure.

Predicting demand accurately is an important part of the field of inventory. If inventory can be accurately predicted, a large amount of unnecessary inventory may be reduced to achieve a cost-saving effect while satisfying customer needs. The longer the system runs, the greater the savings. In terms of service parts, during a specific time from the start to the end of product service time, necessary parts are to be provided to meet the needs of customers for repair or replacement. For suppliers, if the demand for parts can be predicted and handled more accurately, parts inventory may be circulated in a shorter time to create revenue and reduce the cost backlog caused by inactive parts.

Therefore, forecasting may be an important part of business planning. For example, entities may forecast the volume of sales for an item at different asking prices to determine a suitable asking price for the item. As another example, the entities may forecast the volume of sales for different items to determine how resources should be allocated for the manufacturing of those items.

Further, for investors, it is important these days to have an adequate understanding of business entities or enterprises or any business organization before making any financial investment. One of the primary requirements for making an informed investment decision is not only the ease of access to historical financial data on the company but also have the ability to assess the future financial performance of the company.

For instance, for forecasting sales of an enterprise, the traditional forecasting techniques compare historical asking price increases, historical asking price decreases, historical offered discounts, and other historical “events” on the part of an enterprise with historical sales volumes for that enterprise to forecast the volume of sales for that enterprise.

Further, navigating the complexities of traditional forecasting techniques is a daunting task due to intricate supply chains and the multitude of factors influencing demand. Lengthy sales cycles and dependencies on shifting economic conditions, market trends, and customer behaviours all add layers of complexity to accurately predicting demand.

Furthermore, traditional forecasting techniques primarily rely on stable yet often delayed sources like government and industry reports, offering a macro-level perspective. However, these forecasting models struggle to deliver timely and accurate predictions during volatile market conditions.

Therefore, there is a need for an alternative solution that may overcome above discussed limitations.

The drawbacks/difficulties/disadvantages/limitations of the conventional techniques explained in the background section are just for exemplary purposes and the disclosure would never limit its scope only such limitations. A person skilled in the art would understand that this disclosure and below mentioned description may also solve other problems or overcome the other drawbacks/disadvantages

### SUMMARY

This summary is provided to introduce a selection of concepts, in a simplified format, that are further described in the detailed description of the invention. This summary is neither intended to identify essential inventive concepts of the invention nor is it intended for determining the scope of the invention.

According to an aspect of the present disclosure, a method for financial forecasting is disclosed. The method includes categorizing one or more first content documents into a plurality of categories of interest. The one or more first content documents are obtained from a plurality of content sources. Further, the method includes computing a first relevancy score for each of the categorized one or more first content documents based on expert-input from real-world. The expert-input indicates a knowledge bank comprising impact of categorization on one or more entities. Furthermore, the method includes determining one or more second content documents among the categorized one or more first content documents based on correlating the first relevancy score with a predefined threshold score. The one or more second content documents correspond to the one or more entities. The method further includes determining time-series data based on computing an impact factor associated with each of a set of attributes associated with the one or more second content documents. The impact factor indicates a significant quantification of a subsequent impact corresponding to the one or more entities in response to the one or more second content documents. Moreover, the method includes generating disruption indexes based on integrating the determined time-series data and predefined one or more knowledge bases. The disruption indexes indicate variables for training a time-series model. The method further includes generating a forecast of the one or more entities based on the generated disruption indexes.

According to another aspect of the present disclosure, a system for financial forecasting is disclosed. The system includes a memory. The system further includes at least one processor in communication with the memory. The at least one processor is configured to categorize one or more first content documents into a plurality of categories of interest. The one or more first content documents are obtained from a plurality of content sources. The at least one processor is configured to compute a first relevancy score for each of the categorized one or more first content documents based on expert-input from real-world. The expert-input indicates a knowledge bank comprising impact of categorization on one or more entities. Further, the at least one processor is configured to determine one or more second content documents among the categorized one or more first content documents based on correlating the first relevancy score with a predefined threshold score. The one or more second content documents correspond to the one or more entities. Furthermore, the at least one processor is configured to determine time-series data based on computing an impact factor associated with each of a set of attributes associated with the one or more second content documents. The impact factor indicates a significant quantification of a subsequent impact corresponding to the one or more entities in response to the one or more second content documents. Moreover, the at least one processor is configured to generate disruption indexes based on integrating the determined time-series data and predefined one or more knowledge bases. The disruption indexes indicate variables for training a time-series model. The at least one processor is configured to generate a forecast of the one or more entities based on the generated disruption indexes.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF THE FIGURES

These and other features, aspects, and advantages of the present invention will become better understood when the following detailed description is read with reference to the accompanying drawings in which like characters represent like parts throughout the drawings, wherein:

FIG. 1 illustrates a schematic block diagram depicting an environment for the implementation of a system for financial forecasting, in accordance with an embodiment of the present disclosure;

FIG. 2 illustrates a schematic block diagram of the system for financial forecasting, in accordance with an embodiment of the present disclosure;

FIG. 3 illustrates a schematic block diagram depicting a plurality of modules, in accordance with an embodiment of the present disclosure;

FIG. 4 illustrates a flowchart depicting an exemplary method for financial forecasting, in accordance with an embodiment of the present disclosure; and

FIG. 5 illustrates a flowchart depicting sub-steps for categorizing one or more first content documents, in accordance with an embodiment of the present disclosure;

FIG. 6 illustrates a flowchart depicting sub-steps for computing a first relevancy score, in accordance with an embodiment of the present disclosure; and

FIG. 7 illustrates a flowchart depicting a forecasting pipeline, in accordance with an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION OF THE FIGURES

For the purpose of promoting an understanding of the principles of the invention, reference will now be made to the various embodiments and specific language will be used to describe the same. It should be understood at the outset that although illustrative implementations of the embodiments of the present disclosure are illustrated below, the present invention may be implemented using any number of techniques, whether currently known or in existence. The present disclosure is not necessarily limited to the illustrative implementations, drawings, and techniques illustrated below, including the exemplary design and implementation illustrated and described herein, but may be modified within the scope of the present disclosure.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

It is to be understood that as used herein, terms such as, “includes,” “comprises,” “has,” etc. are intended to mean that the one or more features or elements listed are within the element being defined, but the element is not necessarily limited to the listed features and elements, and that additional features and elements may be within the meaning of the element being defined. In contrast, terms such as, “consisting of” are intended to exclude features and elements that have not been listed.

The embodiments herein and the various features and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

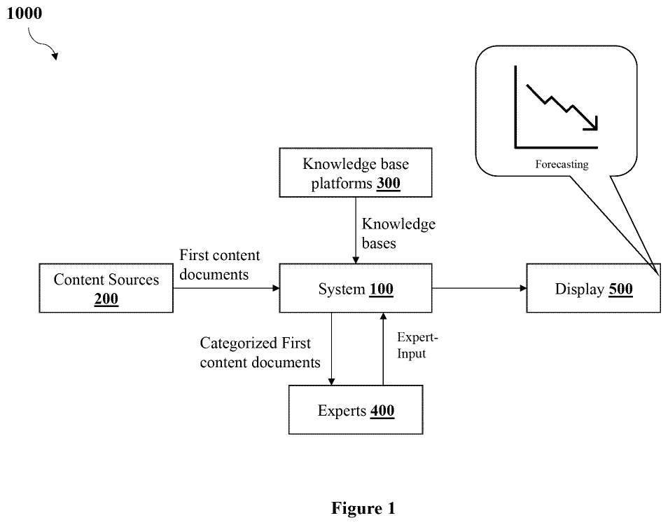

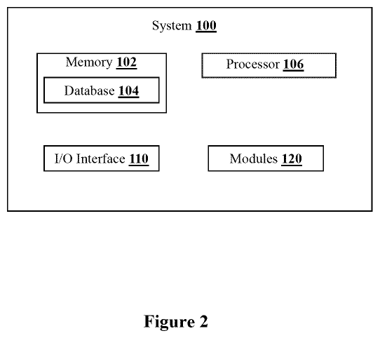

FIG. 1 illustrates a schematic block diagram depicting an environment for the implementation of a system 100 for financial forecasting, in accordance with an embodiment of the present disclosure. In an embodiment, the environment 1000 may include the system 100 may be configured to receive one or more first content documents from a plurality of content sources 200. In an embodiment, the first content documents may include but are not limited to trends and/or news articles. Further, the system 100 may be configured to receive predefined one or more knowledge bases from a plurality of knowledge base platforms 300 which is discussed in the below paragraphs of the description. In an embodiment, the system 100 may be configured to categorize the one or more first content documents. Further, the system 100 may be configured to receive expert input from one or more experts 400 on the categorized one or more first content documents. Furthermore, the system 100 may be configured to generate a forecast based on the expert-input and one or more knowledge bases. Preferably, the generation of the forecast may be explained in detail in conjunction with FIGS. 2-7. Further, the generated forecast may be displayed in a display 500.

FIG. 2 illustrates a schematic block diagram of the system 100 for financial forecasting, in accordance with an embodiment of the present disclosure.

In an embodiment, the system 100 may include a memory 102 including a database 104, a processor 106 communicatively coupled with the memory 102, an Input/Output (I/O) interface 110, and a plurality of modules 120. In an embodiment, the system 100 may be implemented by a User Equipment (UE). In a non-limiting example, the UE may be a smartphone, a laptop computer, a desktop computer, a Personal Computer (PC), a notebook, a tablet or a smartwatch.

In another embodiment, the system 100 may be implemented by a cloud-based system, that may include the server, specifically a cloud server. In yet another embodiment, the system 100 may be implemented by a combination of the UE and the server. More specifically, one or more steps may be performed in the UE and remaining steps may be performed by the server.

In one embodiment, the memory 102 is configured to store instructions executable by the processor 106. In one embodiment, the memory 102 communicates via a bus within the system 100. The memory 102 includes but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory includes a cache or random-access memory (RAM) for the processor 106. In alternative examples, the memory 102 is separate from the processor 106 such as a cache memory of a processor, the system memory, or other memory. The memory 102 is an external storage device or the memory 102 is for storing data. The memory 102 is operable to store instructions executable by the processor 106. The functions, acts, or tasks illustrated in the figures or described are performed by the programmed processor for executing the instructions stored in the memory 102. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies include multiprocessing, multitasking, parallel processing, and the like.

As a non-limiting example, the processor 106 may be a single processing unit or a set of units each including multiple computing units. The processor 106 may be implemented as one or more microprocessors, microcomputers, microcontrollers, digital signal processors, central processing units, state machines, logic circuitries, and/or any devices that manipulate signals based on operational instructions (computer-readable instructions) stored in the memory 102. Among other capabilities, the processor 106 may be configured to fetch and execute computer-readable instructions and data stored in the memory 102. The processor 106 includes one or a plurality of processors. The plurality of processors is further implemented as a general-purpose processor, such as a central processing unit (CPU), an application processor (AP), or the like, a graphics-only processing unit, such as a graphics processing unit (GPU), a visual processing unit (VPU), and/or an AI-dedicated processor such as a neural processing unit (NPU). The plurality of processors controls the processing of the input data in accordance with a predefined operating rule or an artificial intelligence (AI) model stored in the memory 102. The predefined operating rule or the AI model is provided through training or learning.

The processor 106 may be disposed in communication with one or more input/output (I/O) devices via the Input/Output (I/O) interface 110. The I/O interface 110 employs communication code-division multiple access (CDMA), high-speed packet access (HSPA+), global system for mobile communications (GSM), long-term evolution (LTE), WiMax, and the like, etc. In another embodiment of the present invention, the I/O interface 110 employs ethernet, industrial wireless Local Area Network (LAN), Process Field Bus (PROFIBUS), Actuator Sensor (AS) Interface, and the like.

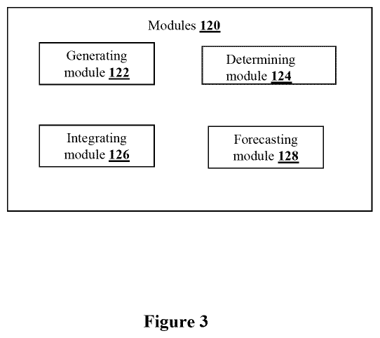

FIG. 3 illustrates a schematic block diagram depicting a plurality of modules 120, in accordance with an embodiment of the present disclosure. The plurality of modules 120 may include the one or more instructions that may be executed to cause the system 100, in particular, the processor 106 of the system 100, to execute the one or more instructions.

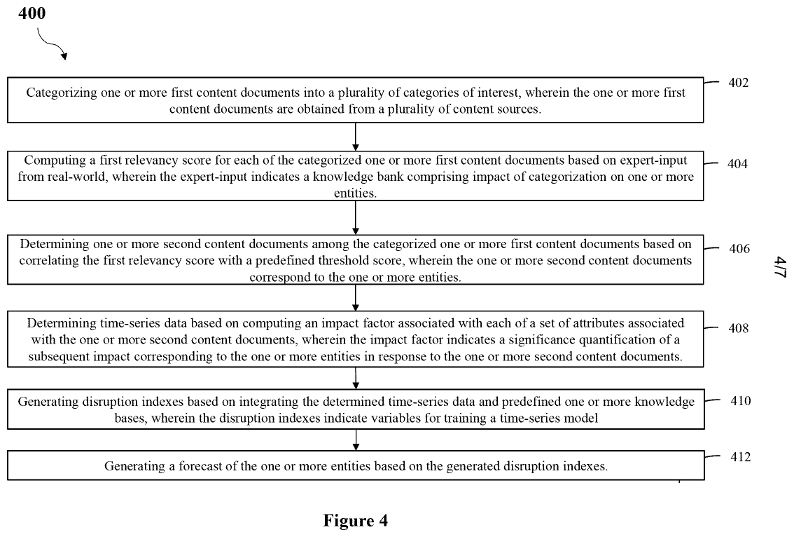

The plurality of modules 120 may include a generating module 122, a determining module 124, an integrating module 126, and a forecasting module 128. In an embodiment, the generating module 122, the determining module 124, the integrating module 126, and the forecasting module 128 may be in communication with each other. In an embodiment, the plurality of modules 120 may be configured to perform various operations or steps that may be discussed and explained in detail in conjunction with FIGS. 4-7.

Preferably, a detailed explanation of various functions of the processor 106, and/or the plurality of modules 120 may be explained in view of FIGS. 4-7.

FIG. 4 illustrates a flowchart depicting an exemplary method 400 for financial forecasting, in accordance with an embodiment of the present disclosure. In an embodiment, the method 400 is a computer-implemented method 400 that is explained in detail in the below paragraphs.

Referring to FIG. 4, the method 400 may begin with step 402 which may include categorizing, via the generating module 122, the one or more first content documents into a plurality of categories of interest. In an embodiment, the one or more first content documents are obtained from the plurality of content sources 200. In an embodiment, the one or more first content documents may include but are not limited to trends and/or news articles. In an exemplary scenario, there is a pandemic lockdown in X country. In this case, the pandemic lockdown may be a trend that is obtained from the plurality of content sources 200. Further, the news articles associated with the trend are obtained from the plurality of content sources 200.

In one embodiment, the trends may be topics that gain widespread attention and engagement, to capture a broad spectrum of organic discussions and understand emerging issues within online communities. More specifically, a dataset associated with the trends may be obtained from online/offline content sources which may contain data associated with trending topics. This dataset may be chosen for its relevance and completeness. The dataset associated with the trends may be updated regularly to track popular trends, assessing their engagement levels, and noting a duration of these trends.

Further, the obtained trends may be used as a basis for gathering relevant news articles from the plurality of content sources 200. The plurality of content sources 200 may include but is not limited to newspapers, blogs, websites, or the like. In an exemplary scenario, the news titles and concise descriptions are provided by editors from electronic newspapers. In an exemplary embodiment, the news articles for a predefined time period may be selected by the system 100, thereby obtaining the news articles which are related to trends. In an exemplary scenario, the news articles are obtained which are published within a 15-day window before and after the initial emergence of the trends, discarding any data outside this range, thereby obtaining the one or more first content documents. In an exemplary scenario, 4000 trends and 20000 news articles may be obtained for a predefined time period of 1 month. In an embodiment, exemplary trends and the news articles associated with the trends may be illustrated in Table-1 below:

TABLE 1

| Date | News | Trends | Publisher |
|---|---|---|---|
| DD/MM/ | The pandemic lockdown | Pandemic | XYX news |
| YYYY | may have a huge impact | Lockdown in a | |
| | on the supply chain this | targeted city | |
| | month. | | |
| DD/MM/ | The pandemic lockdown | Logistic delayed in | ABC News |
| YYYY | has caused a logistic | the targeted city | |
| | delay | | |

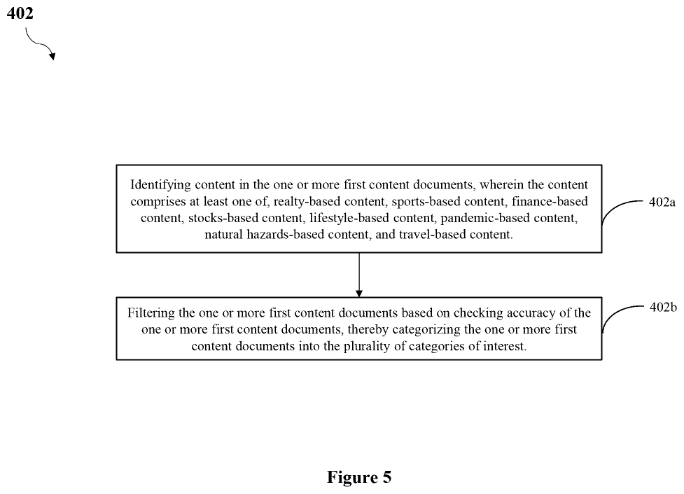

In an embodiment, categorizing the one or more first content documents into a plurality of categories of interest is discussed in conjunction with FIG. 5.

FIG. 5 illustrates a flowchart depicting sub-steps for categorizing the one or more first content documents, in accordance with an embodiment of the present disclosure.

At sub-step 402a, the step 402 may include the identifying content in the one or more first content documents. In an embodiment, the content may include at least one of, realty-based content, sports-based content, finance-based content, stocks-based content, lifestyle-based content, pandemic-based content, natural hazards-based content, and travel-based content. In an exemplary scenario, there is news of XYZ country winning a World Cup in a football match. In this case, the news is identified as the sports-based content.

Further, at sub-step 402b, the step 402 may include filtering the one or more first content documents based on checking accuracy of the one or more first content documents. Thus, categorizing the one or more first content documents into a plurality of categories of interest using a classification model. In an exemplary scenario, a targeted entity is having a business related to cricket, and the news identified is of XYZ country winning a World Cup in a football match and other news is related to a sportsperson hitting a century in a cricket match. Therefore, in this case, the news associated with the football match is filtered out.

Referring back to FIG. 4, at step 404, the method 400 includes computing, via the determining module 124, a first relevancy score for each of the categorized one or more first content documents based on expert-input from the real-world. In an embodiment, the first relevancy score is indicative of the relevancy of each first content document corresponding to the one or more entities. The expert-input is received from the experts' 400, which indicates a knowledge bank that includes the impact of categorization on one or more entities. In an embodiment, the expert input may include comments provided by the experts' 400 which may provide details on the impact of each first content document on the one or more entities.

More preferably, the In an exemplary scenario, the one or more entities may be referred to as a target enterprise or a corporation for which the forecast is generated within the scope of the present disclosure.

Preferably, in an exemplary scenario, the expert-input may include data received from sales managers across automotive, Industrial, ICT, Realty, and other divisions, spanning over time. In an embodiment, the expert input may be obtained to determine the first relevancy score associated with each of the categorized one or more first content documents. Further, the data may include for example obtaining 5,000 samples of sales of products associated with the target enterprise from Month of January to July. After, obtaining the samples, stakeholders read news articles and provided insights in a structured format, including comments, industry categorization, and sentiment value for events, indicating their impact on respective markets. For example, if a news article is very relevant to the targeted enterprise, then the first relevancy score is computed for the news article which is determined as 72%. In an exemplary embodiment, the expert input may be represented as textual data illustrated in Table 2 below:

TABLE 2

| | | | Sentiment |
|---|---|---|---|
| | | | value |
| Date | Comments | Industry | (−5 to 5) |
| DD/MM/ | Oil prices have risen wildly, the | Industry | −5 |
| YYYY | impact of the epidemic has been | | |
| | serious, the air-conditioning home | | |
| | appliance market has gradually | | |
| | declined | | |
| DD/MM/ | Logistic disruption due to the | ICT | 4 |
| YYYY | lockdown in ABC state in April. | | |

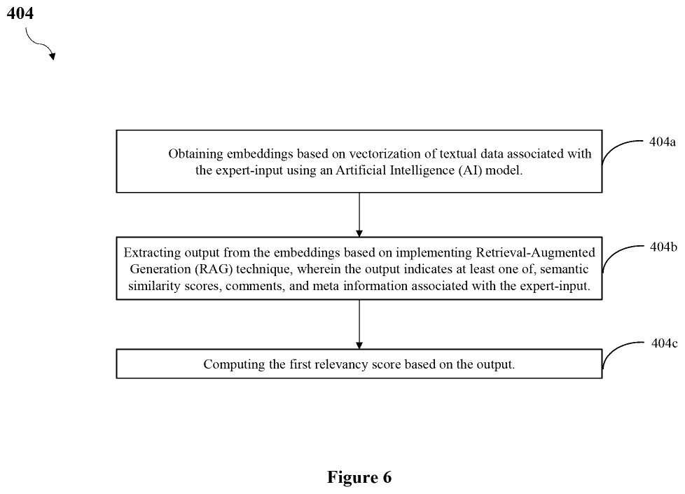

FIG. 6 illustrates a flowchart depicting sub-steps for computing the first relevancy score, in accordance with an embodiment of the present disclosure.

At sub-step 404a, the step 404 may include obtaining embeddings based on the vectorization of textual data associated with the expert-input using an Artificial Intelligence (AI) model. In an exemplary embodiment, textual data herein refers to comments obtained in the expert-input. Preferably, Natural language processing (NLP) tasks such as data cleaning and preprocessing may be used to convert comments into vectors, which are then stored in a vector database. Thereafter, the AI model such as embedding models may be used to convert the text comments in the embeddings. In an exemplary scenario, the text comments indicate expert views which are given by the experts' 400.

Further, at sub-step 404b, the step 404 may include extracting output from the embeddings based on implementing Retrieval-Augmented Generation (RAG) technique into the vector database. In an embodiment, the output indicates at least one of, the semantic similarity scores, the comments, and the meta-information associated with the expert-input as illustrated in Table-2. In an exemplary embodiment, the most relevant insights from the vector database of emerging news may be extracted by implementing a cosine similarity in the vector database. In an exemplary scenario, when a query such as a news article is made to the five vector databases, each database returns N results along with their cosine similarity scores. For example, if N is set to 1, it may return 5 results. For visualization purposes, we set N to 3; however, in our pipeline, we set it to 1. To enhance the relevancy of the retrieval, we developed a “relevancy score module” based on the output from the vector databases. Further details are discussed in Algorithm 1. Consequently, only one relevant document is retrieved for each news item, supported by its semantic similarity scores, along with its meta-information.

Again, referring to FIG. 4, at step 406, the method 400 may include determining, via the determining module 124, one or more second content documents among the categorized one or more first content documents based on correlating the first relevancy score with a first predefined threshold score. More specifically, the one or more second documents are determined when the first relevancy score exceeds the first predefined threshold score. The predefined threshold score is indicative of a limit for analyzing the relevancy of the categorised one or more first content documents corresponds to the one or more entities.

In embodiment, the one or more second content documents correspond to the one or more entities. Preferably, the one or more second content documents may indicate relevancy corresponding to the one or more entities.

In an exemplary scenario, the first relevancy score associated with three news articles may be determined to be 72%, 74%, and 65% respectively, thus indicating the relevancy of these news articles corresponding to the one or more target entities. Further, the first relevancy score for each news article is correlated with the predefined threshold score which is about for example 70%. Thereafter, the news with 65% of the first relevancy score is filtered out/eliminated upon determining that the first relevancy score is less than 70%. Accordingly, the news with the first relevancy score of 72% and 74%, are determined as the one or more second content documents that are relevant to the one or more entities, for example, pertinent to a particular company's products.

In another embodiment, the method 400 may include a step of obtaining historical input based on correlating one or more past content documents and the one or more first content documents. In an embodiment, historical input may refer to events associated with the one or more first content documents that occurred in the past. In an exemplary scenario, the news articles related to a natural calamity are trending. In this case, the news articles related to that natural calamity that occurred in the past are extracted and correlated with the current trending news.

Further, the second relevancy score associated with the one or more first content documents is determined based on the historical input. In an embodiment, the past news articles and the impact these news articles had on the one or more entities in the past are analyzed. In an exemplary scenario, two past news articles are obtained that are related to tsunamis, and the targeted enterprise is in the business of fisheries-related products. In this case, the news articles analyzed and determined that the event had decreased sales of the targeted enterprise in the past. Therefore, in this manner, the past news articles are correlated with the trending news articles to obtain the similarity between these news articles. Accordingly, the second relevancy score associated with the one or more first documents i.e., trending news articles is determined. For example, the second relevancy score for two trending news articles is 67% and 70% respectively.

Further, the method 400 may include a step of determining the one or more second documents when the second relevancy score exceeds a second predefined threshold score. In an exemplary embodiment, the second predefined score is 65%, and the second relevancy score associated with the two trending news articles is 67% and 70% respectively. Therefore, the second relevancy score associated with these two news articles exceeds 65%. Accordingly, these two trending news articles are determined as the one or more second content documents.

In various embodiments, the database may be updated regularly to efficiently determine the relevancy scores. For instance, the database may be updated monthly. For instance, when calculating the relevancy scores in month of April, data up to March may be utilized. Similarly, for the month of May, data up to April may be utilized. This process helps us identify the relevance of emerging trends in relation to past trends data, allowing us to gauge the impact of those events.

In one embodiment, the method 400 may include a step of obtaining the set of attributes. In an embodiment, the set of attributes is obtained based on analyzing the one or more second content documents. In an embodiment, the set of attributes may include but is not limited to at least one of, the first relevancy score, a first sentiment, a hot index, a second sentiment, uniqueness, a category, an industry, and the duration of the one or more second content documents.

In an embodiment, the hot index associated with the one or more second content documents may be obtained by analyzing topics associated with the one or more second content documents in various trend analyzing platforms. In an embodiment, the hot index may indicate topics associated with the one or more second content documents trending beyond a predefined range of numbers. Preferably, the current popularity or attention the trend is receiving, as provided by the various platforms. In an embodiment, the predefined range of numbers may indicate a number of users paying attention to the trending topics. In an exemplary embodiment, the predefined range of numbers may be about 3 to 7 million. In an exemplary scenario, the topic has been trending for the last 5 days and more than 5 million users have viewed the news articles associated with the topic. Further, these news articles are also determined as relevant for the targeted enterprise. Therefore, the topic comes in the category of the hot index.

Further, the set of attributes may include the first sentiment that may be obtained based on expert views from the real-world. In an embodiment, the expert views are obtained when the one or more second content documents are analyzed by the one or more experts 400 and provide their views on the second content documents. In an exemplary embodiment, the expert views herein may refer to the impact the one or more second content documents may have on the one or more entities. The impact may be defined as a positive impact, a negative impact, and a neutral impact. Preferably, the one or more second content documents may be assigned with the sentiment value within a predefined range, for example in a range of about −5 to 5. The one or more second documents with the value of more than 0 may be treated as having a positive impact on the one or more entities. Further, the one or more second documents with a first sentiment value of less than 0 may be treated as having the negative impact on the one or more entities. Furthermore, the one or more second documents with the first sentiment value of 0 may be considered as having a neutral impact on the one or more entities.

In an exemplary scenario, the positive impact may indicate an improvement in the sales of the products associated with the target enterprise. In another exemplary scenario, the negative impact may indicate a reduction in the sales of the products associated with the target enterprise. In yet another exemplary scenario, the neutral impact may indicate an average sale of the products associated with the target enterprise.

In an exemplary scenario, the determining module 124 may be configured to determine the sentiment values associated with the one or more second documents as 4, 0, and −2 respectively. In this case, the news articles with the value of 4 may have a positive impact on the targeted enterprise. In another case, the news articles with the sentiment value of 0 may have a neutral impact on the targeted enterprise. In yet another case, the news articles with the sentiment value of −2 may have a negative impact on the targeted enterprise.

In one embodiment, the set of attributes may include the second sentiment. Further, the set of attributes may include the second sentiment that may be at least one of, a positive impact, a negative impact, and a neutral impact on the one or more entities using a sentiment AI model based on the one or more second content documents. Preferably, the one or more second content documents may be assigned with a news sentiment value within a predefined range, for example in a range of about 0 to 2. In an exemplary scenario, the news articles may be assigned the news sentiment value of 0, which means the impact may be the negative impact. In another exemplary scenario, the news articles may be assigned the news sentiment value of 1, which means the impact may be the neutral impact. In yet another exemplary scenario, the news articles may be assigned the news sentiment value of 2, which means the impact may be the positive impact.

In an exemplary embodiment, the second sentiment may also be referred to as news sentiment within the scope of the present disclosure. In an embodiment, the second sentiment may offer valuable insights into societal mood and potential economic impact. Therefore, the second sentiment may be assigned with news sentiment values. More preferably, one or more large language models (LLMs) may be trained on the database 104 such as a corpus. These models may be tuned for using refining techniques to label the second sentiment with a plurality of labels as positive, neutral, and/or negative.

In an exemplary embodiment, the performance of these models is evaluated using a predefined testing dataset, which may serve both for fine-tuning the models and benchmarking the performance of these models. In an exemplary scenario, three LLMs are used within the scope of the present disclosure. These fine-tuned LLMs are then applied to the one or more second content documents to extract sentiment information. In an exemplary embodiment, the news sentiment values may be computed by averaging the outputs of all three models in a cascaded manner.

In one embodiment, the set of attributes may include the category based on the industry associated with the one or more second content documents. In an embodiment, the category be obtained by utilizing the expert-input. More specifically, the expert-input may include the meta-information that may include the industry associated with the one or more second documents. In an exemplary scenario, the news articles are obtained that are related to XYZ country winning a world cup in football. In this case, these news articles may be considered as relevant to the game industry.

In one embodiment, the set of attributes may include the uniqueness associated with the one or more second content documents. In an embodiment, a score may be generated based on a number of distinct publishers associated with each of the one or more second content documents. For example, an article published by 9 different publishers would have a higher score, say a score of 9.

In one embodiment, the set of attributes may include the duration associated with the trends associated with the one or more second content documents. In an embodiment, the duration may indicate a period for which trends may persist. In an exemplary embodiment, the trends and the news articles may last for a predefined time in the database 104. For example, the trends and the news articles may last up for about 7 days, particularly during challenging periods like pandemic lockdowns, highlighting their prolonged influence beyond daily news cycles.

In one embodiment, the method 400 may include a step of computing an impact factor associated with each of the set of attributes associated with the one or more second content documents. In an embodiment, the impact factor indicates a significant quantification of a subsequent impact corresponding to the one or more entities in response to the one or more second content documents. In an exemplary embodiment, the impact factor may help to indicate stable and turbulent periods associated with the one or more entities.

In an embodiment, the first sentiment may have a greater impact corresponding to the one or more entities. Thus, may have a higher impact as compared to other attributes. Further, the impact associated with the remaining attributes may have the same impact factor. However, this should not be construed as a limitation of the present disclosure. In another embodiment, the impact associated with the remaining attributes may vary.

In an exemplary scenario, when the first sentiment is determined for the relevant news article. The first sentiment, i.e., the expert views indicates that the event associated with the news article may have a positive impact on the targeted enterprise. On the other hand, the second sentiment is determined for the same news article, and is determined that the news article may have a neutral impact on the targeted enterprise. Subsequently, a higher weightage is given to the first sentiment over the second sentiment, and the impact factor is determined for each of the first sentiment and the second sentiment. Preferably, the impact factor may help to indicate how much impact the news article may make on the targeted enterprise. For example, the impact factor with a value of about 9 is given to the first sentiment, which means that the event associated with the news articles may increase sales of products associated with the targeted enterprise.

Referring to FIG. 4, at step 408, the method 400 may include determining, via the determining module 124, time-series data based on the computed impact factor associated with each of a set of attributes. In an embodiment, the time-series data may be determined over time using a time-series model. In an exemplary scenario, the time-series data may be determined on a daily, weekly, and/or monthly basis.

In various embodiments, the system 100 may obtain one or more predefined knowledge bases from the plurality of knowledge base platforms 400 available in the market. The one or more predefined knowledge bases may be essential for informed decision-making and strategic planning across different sectors and societal levels. In an exemplary scenario, the one or more predefined knowledge bases may indicate data associated with the one or more entities such as financial information. Preferably, the predefined one or more knowledge bases may include but not limited to a Consumer Price Index (CPI) and a Purchasing Managers Index (PMI), industrial production, Gross Domestic Product (GDP), Exchange-Traded Fund (ETF) baseline, forex, sector-specific ETF, commodities, and stocks data, or the like. In an exemplary scenario, stock information associated with the targeted enterprise is obtained from a stock data platform. The stock information may include but is not limited to the targeted enterprise's performance at present and a predicted performance of the target enterprise after a few months.

In an embodiment, the one or more predefined knowledge bases may be categorized into hard indicators, soft indicators, and high-frequency indicators.

In one embodiment, the hard Indicators may be based on actual, measurable, and reliable data reported by government agencies or reputable institutions, such as GDP, industrial production, housing data, the inflation rate, and the interest rate. These indicators may provide a stable economic backdrop.

In one embodiment, the soft Indicators may be based on surveys and perceptions, often available more quickly than hard indicators. Examples may include the Purchasing Managers' Index, Consumer Price Index, etc. In an embodiment, the soft indicators may provide early signals of changes in economic conditions helping policymakers, analysts, and investors gauge the mood and expectations of different economic agents, which may influence economic decisions and outcomes.

In one embodiment, the high-frequency indicators may provide near real-time data, offering timely insights that help businesses anticipate demand shifts during unforeseen events, enabling prompt strategy adjustments and maintaining operational resilience. These include stock market data, transportation data, and freight data.

Referring to FIG. 4, at step 410, the method 400 may include generating, via the generating module 122, disruption indexes based on integrating the determined time-series data and the one or more predefined knowledge bases. In an embodiment, the integrating module 126 may be configured to integrate the determined time-series data and the one or more predefined knowledge bases. In an embodiment, the integration may help to track the turbulent period corresponding to the market. In an embodiment, the disruption indexes indicate variables for training a time-series model that may be used to generate the forecasting. More specifically, the disruption may track irregularities or unexpected events that may impact market stability such as sudden price fluctuations, unusual trading volumes, or anomalies that deviate from normal market behaviours.

In an exemplary use case, firstly, daily data associated with the one or more second content documents and the one or more predefined knowledge bases are grouped into semi-monthly (bi-weekly) intervals. Prior to this grouping, one-hot encoding for nominal variables and aggregating them by summing their values during aggregation. For interval variables, a mean score is calculated. Further, missing values are addressed using unconditional mean imputation, with the exception of a pandemic category.

In an exemplary scenario, in the case of pandemic lockdown, for a period before the pandemic outbreaks, which began in 2019, a value of “0” is imputed. For the period from late 2019 to October 2021, the mean score is used to fill data gaps. This may reduce data sparsity, particularly in categorical variables, and retain only the second content documents that may be relevant to the one or more entities. Further, the data associated with the one or more second content documents and the one or more knowledge bases are collected for a predefined month. Further, the data is divided based on dividing the month into two halves. For instance, for the pandemic category, columns “1SM_Pandemic” and “2SM_Pandemic” may be created to indicate the first and second halves of the month, respectively.

Again, referring to FIG. 4, at step 412, the method 400 may include generating, via the forecasting module 128, the forecast of the one or more entities based on the generated disruption indexes. In an embodiment, the forecast may be generated based on using a forecasting model. In an embodiment, the forecasting model may be the time-series model that may be trained using the generated disruption indexes to forecast the one or more entities in a time-series graph. This time-series forecasting enables the one or more entities to make efficient strategies in a turbulent period, particularly in an economic crisis situation. In an exemplary scenario, the targeted enterprise sells around 15000 products in a single month when there is market stability. However, in a case when the pandemic situation occurs, the system 100 may forecast that sales may decrease by 50% and demand for products may reduce to 7500 products for next month. Therefore, the system 100 may enable accurate forecasting in a turbulent period.

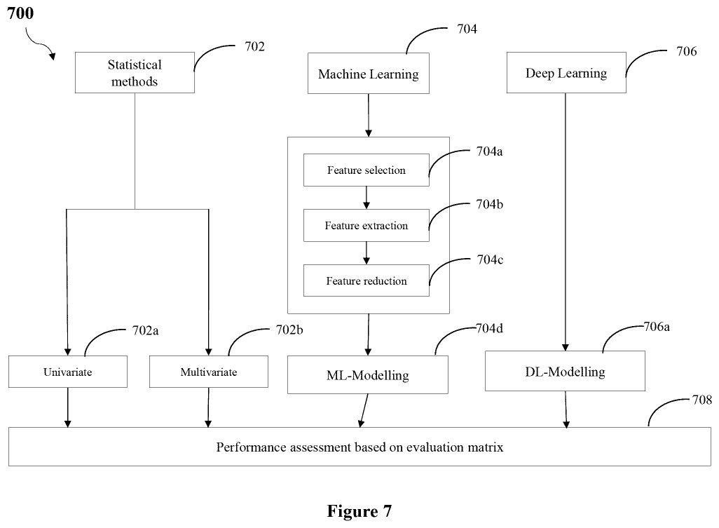

In an embodiment, a forecasting pipeline 700 is illustrated in FIG. 7. In an embodiment, the forecasting may include a combination of statistical methods with AI-driven approaches. At block 702, statistical methods such as univariate and multivariate models as illustrated in blocks 702a and 702b are employed to effectively capture linear relationships and volatility but often struggle with the complexity of high-frequency data. To address this, the machine learning model as illustrated in block 704 employs advanced time series forecasting techniques through a three-step feature engineering process.

In an embodiment, at block 704, the machine learning model may employ advanced time series forecasting techniques to the one or more second documents through a three-step feature engineering process as illustrated in blocks 704a, 704b, 704c. More specifically, at block 704a, the process includes comprehensive automatic feature selection from the one or more second content documents. The automatic feature selection may include techniques such as forward and backward selection, Recursive Feature Elimination with Cross-Validation (RFECV), and sequential selection.

Further, at block 704b, a feature generation is conducted using time series feature extractors on the selected features associated with the one or more second content documents. Furthermore, at block 704c, the process may include correlation-based feature reduction and Principal Component Analysis (PCA) to streamline the data associated with the one or more second content documents. Furthermore, at block 704d, the extracted features associated with the one or more second content documents are integrated with machine learning models for forecasting purposes.

At block 706, the forecasting pipeline may further incorporate deep learning models, specifically, at block 706a, Long Short-Term Memory (LSTM) networks, and the Bidirectional Long Short-Term Memory (BiLSTM) approach as illustrated in block 6.

In various embodiments, at block 708, a performance assessment of the forecasting model using evaluation metrics such as Mean Absolute Percentage Error (MAPE) and Mean Absolute Error (MAE) for the selection of the optimum model The best-performing model, as indicated by the lowest error metrics during the validation period, is selected as the candidate for the forecasting task. This pipeline automatically runs all possible combinations extensively to achieve the best possible results, ensuring the robustness, fairness, and accuracy of the models.

In various embodiments, the present disclosure at least provides the following advantages:
The present disclosure may improve forecasting, specifically during emergencies such as pandemics or other natural disasters, where rapid market shifts significantly impact demand dynamics.
Further, the present disclosure may provide a precise and actionable forecast, enabling businesses to adapt quickly to market changes and stay attuned to immediate market fluctuations in a dynamic business-to-business (B2B) landscape.

The forecasting model has shown significant improvement over existing models by up to 8.5% for industrial products.

Moreover, the present disclosure enables the incorporation of the impact factor could be a promising approach. This may help to activate and deactivate variables associated with disruption indexes more effectively, thereby optimizing forecasting in response to market volatility.

The embodiments disclosed herein can be implemented through at least one software program running on at least one hardware device and performing network management functions to control the elements. The elements can be at least one of a hardware device or a combination of hardware devices and software modules.

It is understood that terms including “unit” or “module” at the end may refer to the unit for processing at least one function or operation and may be implemented in hardware, software, or a combination of hardware and software.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

The foregoing description of the specific embodiments will so fully reveal the general nature of the embodiments herein that others can, by applying current knowledge, readily modify and adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

We claim:

1. A method for financial forecasting, the method comprising:
categorizing one or more first content documents into a plurality of categories of interest, wherein the one or more first content documents are obtained from a plurality of content sources;
computing a first relevancy score for each of the categorized one or more first content documents based on expert-input from real-world, wherein the expert-input indicates a knowledge bank comprising impact of categorization on one or more entities;
determining one or more second content documents among the categorized one or more first content documents based on correlating the first relevancy score with a first predefined threshold score, wherein the one or more second content documents correspond to the one or more entities;
determining time-series data based on computing an impact factor associated with each of a set of attributes associated with the one or more second content documents, wherein the impact factor indicates a significant quantification of a subsequent impact corresponding to the one or more entities in response to the one or more second content documents;
generating disruption indexes based on integrating the determined time-series data and one or more predefined knowledge bases, wherein the disruption indexes indicate variables for training a time-series model; and
generating a forecast of the one or more entities based on the generated disruption indexes.

2. The method as claimed in claim 1, wherein categorizing the one or more first content documents comprises:
identifying content in the one or more first content documents, wherein the content comprises at least one of, realty-based content, sports-based content, finance-based content, stocks-based content, lifestyle-based content, pandemic-based content, natural hazards-based content, and travel-based content; and
filtering the one or more first content documents based on checking accuracy of the one or more first content documents, thereby categorizing the one or more first content documents into the plurality of categories of interest.

3. The method as claimed in claim 1, wherein obtaining the expert-input comprises obtaining the expert-input from the real-world based on correlating the categorized one or more first content documents and an impact made on the one or more entities in response to events associated with each of the categorized one or more first content documents.

4. The method as claimed in claim 1, wherein computing the first relevancy score comprises:
obtaining embeddings based on vectorization of textual data associated with the expert-input using an Artificial Intelligence (AI) model;
extracting output from the embeddings based on implementing Retrieval-Augmented Generation (RAG) technique, wherein the output indicates at least one of, semantic similarity scores, comments, and meta information associated with the expert-input; and
computing the first relevancy score based on the output.

5. The method as claimed in claim 1, wherein determining the one or more second content documents comprise determining the one or more second content documents when the first relevancy score exceeds the first predefined threshold score.

6. The method as claimed in claim 1, wherein prior to determining the one or more second content documents, the method comprises:
obtaining historical input based on correlating one or more past content documents and the one or more first content documents, wherein the historical input indicates events associated with the one or more first content documents that occurred in the past; and
computing a second relevancy score based on the historical input.

7. The method as claimed in claim 6, wherein determining the one or more second content documents comprise determining the one or more second content documents when the second relevancy score exceeds a second predefined threshold score.

8. The method as claimed in claim 1, wherein prior to determining the time-series data, the method comprises:
obtaining the set of attributes based on analyzing the one or more second content documents.

9. The method as claimed in claim 1, wherein obtaining the set of attributes comprises obtaining at least one of, the first relevancy score, a first sentiment, a hot index, a second sentiment, uniqueness, a category, an industry, and duration of the one or more second content documents.

10. The method as claimed in claim 9, wherein obtaining the first sentiment comprises obtaining expert views from the real-world in response to the one or more second content documents.

11. The method as claimed in claim 9, wherein the hot index indicates topics associated with the one or more second content documents trending beyond a predefined range of numbers.

12. The method as claimed in claim 9, wherein obtaining the second sentiment indicates obtaining at least one of, a positive impact, negative impact, and a neutral impact on the one or more entities using a sentiment model based on the one or more second content documents.

13. The method as claimed in claim 1, wherein prior to generating the disruption indexes, the method comprises:
obtaining the one or more predefined knowledge bases from a plurality of knowledge base platforms, wherein the one or more predefined knowledge bases comprise at least one of, a Consumer Price Index (CPI) and a Purchasing Managers Index (PMI), industrial production, Gross Domestic Product (GDP), Exchange-Traded Fund (ETF) baseline, forex, sector-specific ETF, commodities, and stocks data.

14. The method as claimed in claim 1, wherein prior to determining the time-series data, the method comprises:
ranking the one or more second content documents based on the impact factor.

15. The method as claimed in claim 1, wherein generating the forecast comprises generating the forecast in a time-series pattern using the time-series model.

16. A system for financial forecasting, the system comprising:
a memory; and
at least one processor in communication with the memory, wherein the at least one processor is configured to:
categorize one or more first content documents into a plurality of categories of interest, wherein the one or more first content documents are obtained from a plurality of content sources;
compute a first relevancy score for each of the categorized one or more first content documents based on expert-input from real-world, wherein the expert-input indicates a knowledge bank comprising impact of categorization on one or more entities;
determine one or more second content documents among the categorized one or more first content documents based on correlating the first relevancy score with a predefined threshold score, wherein the one or more second content documents correspond to the one or more entities;
determine time-series data based on computing an impact factor associated with each of a set of attributes associated with the one or more second content documents, wherein the impact factor indicates a significant quantification of a subsequent impact corresponding to the one or more entities in response to the one or more second content documents;
generate disruption indexes based on integrating the determined time-series data and one or more predefined knowledge bases, wherein the disruption indexes indicate variables for training a time-series model; and
generate a forecast of the one or more entities based on the generated disruption indexes.

17. The system as claimed in claim 16, wherein to categorize one or more first content documents, the at least one processor is configured to:
identify content in the one or more first content documents, wherein the content comprises at least one of, realty-based content sports-based content, finance-based content, stocks-based content, lifestyle-based content, pandemic-based content, natural hazards-based content, and travel-based content; and
filter the one or more first content documents based on checking accuracy of the one or more first content documents, thereby categorizing the one or more first content documents into the plurality of categories of interest.

18. The system as claimed in claim 16, wherein the at least one processor is configured to:
obtain the expert-input from the real-world based on correlating the categorized one or more first content documents and an impact made on the one or more entities in response to events associated with each of the categorized one or more first content documents.

19. The system as claimed in claim 16, wherein to compute the first relevancy score, the at least one processor is configured to:
obtaining embeddings based on vectorization of textual data associated with the expert-input using an Artificial Intelligence (AI) model;
extract output from the embeddings based on implementing Retrieval-Augmented Generation (RAG) technique, wherein the output indicates at least one of, semantic similarity scores, comments, and meta-information associated with the expert-input; and
compute the first relevancy score based on the output.

20. The system as claimed in claim 16, wherein to determine the one or more second content documents, the at least one processor is configured to:
determine the one or more second content documents when the first relevancy score exceeds the first predefined threshold score.

21. The system as claimed in claim 16, wherein the at least one processor is configured to:
obtain historical input based on correlating one or more past content documents and the one or more first content documents, wherein the historical input indicates events associated with the one or more first content documents that occurred in the past; and
compute a second relevancy score based on the historical input.

22. The system as claimed in claim 16, wherein to determine the one or more second content documents, the at least one processor is configured to:
determine the one or more second content documents when the second relevancy score exceeds a second predefined threshold score.

23. The system as claimed in claim 16, wherein the at least one processor is configured to:
obtain the set of attributes based on analyzing the one or more second content documents.

24. The system as claimed in claim 23, wherein the set of attributes comprises at least one of, the first relevancy score, a first sentiment, a hot index, a second sentiment, uniqueness, a category, an industry, and duration of the one or more second content documents.

25. The system as claimed in claim 24, wherein to obtain the first sentiment, the at least one processor is configured to:
obtain expert views from the real-world in response to the one or more second content documents.

26. The system as claimed in claim 24, wherein the hot index indicates topics associated with the one or more second content documents trending beyond a predefined range of numbers.

27. The system as claimed in claim 24, wherein to obtain the second sentiment, the at least one processor is configured to:
determine at least one of, positive impact, negative impact, and a neutral impact, on the one or more entities using a sentiment model based on the one or more second content documents.

28. The system as claimed in claim 16, wherein the at least one processor is configured to:
obtain the one or more predefined knowledge bases from a plurality of knowledge base platforms, wherein the one or more predefined knowledge bases comprise at least one of, a Consumer Price Index (CPI) and a Purchasing Managers Index (PMI), industrial production, Gross Domestic Product (GDP), Exchange-Traded Fund (ETF) baseline, forex, sector-specific ETF, commodities, and stocks data.

29. The system as claimed in claim 16, wherein the at least one processor is configured to:
rank the one or more second content documents based on the impact factor.

30. The system as claimed in claim 16, wherein the at least one processor is configured to generate the forecast in a time-series pattern using the time-series model.
